(19) United States
(12) Patent Application Publication
(10) Pub. No.: US 2019/0127187 A1
(43) Pub. Date: May 2, 2019

(54) TRANSPORTATION INSTALLATION FOR A CRANE

(71) Applicant: Hans Kunz GmbH, Hard (AT)

(72) Inventor: Georg Klapper, Hard (AT)

(73) Assignee: Hans Kunz GmbH, Hard (AT)

(21) Appl. No.: 16/169,302

(22) Filed: Oct. 24, 2018

(30) Foreign Application Priority Data
Oct. 30, 2017 (AT) A 419/2017

(51) Int. Cl. B66C 13/06

(52) U.S. Cl. CPC B66C 13/06

(57) ABSTRACT

A transportation installation for a crane for transporting at least one container or any other load is provided, and includes at least one crane trolley that is repositionably mountable on a crane girder of the crane, at least eight cables, and at least one load-receiving device that is suspended so as to be liftable and lowerable on the crane trolley by the cables. At least three actuation devices are provided, with each actuation device having a displacement member displaceably mounted and an actuation drive for displacing the position of the displacement member. Two of the cables engage in each case on the respective displacement member, and the transportation installation includes at least one equalization device having a further displacement member on which two of the cables engage, and a restraining device that is capable of being set for selective restraint, wherein the restraining device in a braking state brakes a displacement of the further displacement member more intensely than in the free-running state.

### INCORPORATION BY REFERENCE

The following documents are incorporated herein by reference as if fully set forth: Austrian Patent Application No. A419/2017, filed Oct. 30, 2017.

### BACKGROUND

The present invention relates to a transportation installation for a crane, in particular a gantry crane, for transporting at least one container or any other load, wherein the transportation installation has at least one crane trolley that is capable of being mounted so as to be repositionable on a crane girder of the crane, and at least eight cables, and at least one load-receiving device that is suspended so as to be liftable and lowerable on the crane trolley by the cables, and at least three actuation devices, wherein each actuation device has a displacement member that is mounted so as to be displaceable on a respective guide of the load-receiving device, and an actuation drive for displacing the position of the displacement member relative to the respective guide, wherein two of the cables engage in each case on the respective displacement member. The invention furthermore relates to a method for operating a transportation installation and to a crane having at least one transportation installation.

Transportation installations of the type mentioned above are used in the transportation of containers by a crane. Apart from lifting and lowering, that is to say movements in the vertical direction, relocating containers or other loads in at least one horizontal direction is also necessary in order for the container or the load, respectively, to be set down at a predetermined location, to be transferred to trucks, to be stacked on top of one another, etc. The crane trolley, also referred to as the crane crab, herein typically runs along a main support of a crane and enables the movement of the transportation installation in or counter to a first horizontal direction, while the crane in its entirety is displaceable on crane rails mostly in or counter to a second horizontal direction. Rough positioning of the transportation installation, or of the load-receiving device, respectively, in relation to the container or the other load is thus possible at comparatively high repositioning speeds.

Apart from high repositioning speeds, a precise positioning capability of the load-receiving device at the container pick-up location and at the envisaged container set-down location is also important for a rapid handling of the containers. For so-called fine-positioning, the support structure of the crane and the crane trolley are typically held in position, and the load-receiving device by separate actuation drives, is moved relative to the container, or to the other load, respectively, or to the predetermined container set-down location in a plane that is defined by the first horizontal direction and the second horizontal direction, for example.

The separate actuation drives are fixed, that is to say blocked, during the rough positioning, that is to say in a displacement of the crane and/or the crane trolley along the crane girder, such that undesirable motion overlaps of the numerous drives are suppressed and a simple operation of the crane is guaranteed.

A transportation installation of the type mentioned at the outset is shown in DE 20 2006 000 490 U1. The transportation installation for the fine-positioning of the load-receiving device has four actuation installations. Each of the actuation installations comprises a connecting member which is mounted so as to be displaceable on a guide of the load-receiving device, two of the cables of the transportation installation engaging in each case on said connecting member, and a piston-cylinder unit for displacing the displacement member relative to the guide. The respective connecting member can be fixed at a desired position by the piston-cylinder unit. Furthermore, the displacement of a respective connecting member in relation to the load-receiving device can be released in that the cylinder chambers of the corresponding piston-cylinder unit are shorted.

In the case of containers or other loads having a non-uniform distribution of weight, dissimilarly high cable forces can arise in the cables of the transportation installation. High cable forces in particular drastically reduce the service life of the cables. One possibility for mutually equalizing the cable forces of the cables lies in actuating the actuation drives of the fine-positioning mechanism in a corresponding manner so as to reduce force peaks in the cables. The cable forces could be monitored, for example by sensors. It is also problematic that an operating error of the actuation drives, or a failure of one of the actuation drives, can lead to high cable forces in individual cables.

### SUMMARY

It is an object of the invention to provide an advantageous transportation installation of the above-mentioned type that is of a simple configuration.

This is achieved according to the invention by a transportation installation according to one or more features of the invention.

The invention provides that the transportation installation comprises at least one equalization device having a further displacement member that is mounted so as to be displaceable on a further guide of the load-receiving device and on which two of the cables engage, and a restraining device that is capable of being set for selective restraint, wherein the restraining device is adjustable at least between a braking state and a free running state, and the restraining device in the braking state brakes a displacement of the further displacement member relative to the further guide more intensely than in the free-running state.

The equalization device according to the invention enables in a simple manner the equalizing of dissimilarly high cable forces by way of a self-acting displacement of the further displacement member relative to the further guide. A core concept of the invention lies in that the equalization device enables a displacement of the further displacement member relative to the further guide both during the rough positioning in which the actuation devices are fixed or blocked, respectively, as well as during the fine-positioning.

The restraining device herein is configured such that said restraining device enables a displacement of the further displacement member relative to the further guide also in the braking state, wherein the displacement in the braking state is braked more intensely as compared to the free-running state. The displacement member in terms of the position thereof in relation to the further guide is thus also not held so as to be completely fixed in the braking state. The displacement of the further displacement member relative to the further guide in the braking state enables a self-acting equalizing, that is to say a levelling or balancing, of the cable forces of the cables of the transportation installation in particular even during the rough positioning of the transportation installation, or of the load-receiving device, respectively.

The restraining device in the braking state enables a self-acting and relatively slow equalizing movement by displacing the further displacement member relative to the further guide. Short force impulses, for example due to abrupt movements of the crane trolley or of the crane per se, in the braking state are transferred to the load-receiving device, or to the container or the other load, respectively, without any substantial interfering influence.

The free-running state means that the further displacement member is displaceable in a substantially free manner relative to the further guide. “Substantially” means that the further displacement member, apart from overcoming any dynamic friction or static friction, can be freely displaced relative to the guide, or at least is less restrained or braked, respectively, than in the braking state.

The term “selective restraint” means that the restraint of the displacement capability of the further displacement member relative to the further guide that is caused by the restraining device is selectable or activatable. The term “restraint” in the context of this document is linked to the fundamental displacement capability of the further displacement member relative to the further guide. That is to say that a displacement of the further displacement member relative to the further guide is possible and provided in the braking state of the restraining device, wherein the displacement capability of the further displacement member relative to the further guide is braked more intensely as compared to the free-running state.

In the braking state it can be provided that the restraining device limits the relative speed of the further displacement member relative to the further guide. Alternatively or additionally it can be provided that the restraining device enables the setting of a limit force beyond which a self-acting displacement of the further displacement member relative to the further guide is performed.

The actuation drive of a respective actuation device enables a displacement of the displacement member of the respective actuation device relative to the corresponding guide for fine-positioning the load-receiving device. The restraining device of the at least one equalization device during the fine-positioning is favorably switched to the free-running state, wherein a substantially free displacement of the further displacement member relative to the further guide is possible.

During the rough positioning, that is to say in the event of a movement of the crane and/or of the crane trolley, the position of the displacement member of the respective actuation device in relation to the corresponding guide can be blocked, that is to say fixed. The restraining device of the at least one equalization device during the rough positioning is favorably set to the braking state. On account thereof, a self-acting equalization of the cable forces in the cables of the transportation device can take place by way of a displacement of the further displacement element relative to the further guide in the event of dissimilar cable forces arising.

Due to the self-acting equalization of the cable forces, monitoring installations for measuring the cable forces could be dispensed with, or the number of said monitoring installations could be reduced, on the one hand, and the number of actuation drives can also be reduced, on the other hand. Furthermore, complicated control technology for influencing the cable forces can be dispensed with. Due to the provision of an equalization device according to the invention it is thus possible for the number of actuation devices to be limited to a minimum required for fine-positioning.

The further displacement member of the equalization device in the context of the invention could also be referred to as an equalizing member. The displacement member of the respective actuation device could also be referred to as an actuation member. The restraining device for selective restraint could also be referred to as a switchable damping or braking installation.

A lifting cable which contributes toward lifting the container or any other load and runs continuously between one end that is wound onto a cable drum and the end of the cable that is opposite the cable drum is referred to as a cable in this document. That end of the respective cable that is opposite the cable drum is favorably anchored, in particular by an end-of-cable connection, to one of the displacement members or to the further displacement member. End-of-cable connectors are well-known.

In one alternative embodiment, a respective cable by a deflection roller that is disposed on the displacement member or on the further displacement member could be deflected and that end of the cable that faces away from the cable drum could be anchored to the crane trolley. Two of the cables engage in each case on the respective displacement member or on the further displacement member also in the case of this embodiment. The effective cable forces in the cable are reduced by the deflection of the cable, since a type of pulley block is implemented. The deflection of the cable on the deflection roller could also be referred to as reeving of the cable, or as double-guiding of the cable. It is possible for a smaller cable diameter to be chosen by virtue of the reduced cable forces. That end of the cable that faces away from the cable drum in this instance is favorably anchored or fixed, respectively, to the crane trolley by an end-of-cable connection.

Apart from a cable per se, the term cable or lifting cable, also includes belts or chains. The cable drum, or a respective cable drum, is preferably mounted so as to be rotatable on the crane trolley.

The entirety of the cables which extend between the load-receiving device and the crane trolley forms the so-called cable shaft, also referred to as the cable tower, which extends between the crane trolley and the load-receiving device. The cable shaft can also be referred to as a support unit which supports the load-receiving device and the container or the other load that is optionally fastened thereto. The geometry of the cable shaft depends on the relative position of the load-receiving device in relation to the crane trolley. High dynamic forces which in a corresponding manner can deform the cable shaft arise in the event of acceleration or deceleration procedures of the crane, or of the crane trolley, respectively. The equalization device herein enables dissimilarly high cable forces of the cables of the cable shaft to be equalized or balanced, respectively, during fine-positioning and during rough positioning.

It is preferably provided that the load-receiving device has two mutually opposite longitudinal sides and two mutually opposite end sides that are aligned so as to be orthogonal to the longitudinal sides, wherein one of the guides which is aligned so as to be parallel with the respective longitudinal side or end side is in each case disposed on each of the longitudinal sides and the end sides. In the case of the guides mentioned, those are the guides on which a displacement member of a respective actuation device is displaceably mounted, as well as the guide on which the further displacement member of the at least one equalization device is displaceably mounted. The total number of guides of the load-receiving device thus corresponds to the sum of the number of displacement members of the actuation devices and to the number of further displacement members of the at least one equalization device.

In principle, it would be conceivable for more than one guide to also be disposed on one of the longitudinal sides or one of the end sides. This could be advantageous, for example, in the case of transportation installations for heavy containers or loads.

A respective guide is favorably configured so as to be elongate along a longitudinal axis of the guide. The guide in this instance could also be referred to as a guide rail. The longitudinal axis of a respective guide is preferably aligned so as to be parallel with that respective longitudinal side or end side of the load-receiving device on which the respective guide is disposed.

The equalization device could be disposed on one of the end sides of the load-receiving device. It is particularly preferably provided that the equalization device is disposed on one of the longitudinal sides of the load-receiving device. A respective longitudinal side of the load-receiving device, when viewed orthogonally onto a horizontal plane, has a larger extent than a respective end side.

It is preferably provided that a respective one of the guides of the load-receiving device in a manner relative to a support structure of the load-receiving device is pivotable about a pivot axis that is aligned so as to be parallel with a longitudinal axis of the guide. The guides mentioned of the load-receiving device are again the guides on which a displacement member of a respective actuation device is displaceably mounted, as well as the guide on which the further displacement member of the at least one equalization device is displaceably mounted. By pivoting the respective guide, an alignment of the respective displacement member, or of the further displacement member, respectively, into a plane defined by the respective engaging cables can be performed.

In one potential embodiment it can be provided that the restraining device has a piston-cylinder unit that is capable of being filled with a fluid, and a flow valve for restricting a volumetric flow of the fluid. A flow valve for restricting a volumetric flow is to be understood in that the volumetric flow of the inflowing or outflowing fluid, respectively, into or from the piston-cylinder unit, respectively, is throttled. The flow valve serves for restricting the displacement capability of the piston relative to the cylinder of the piston-cylinder unit, and thus brakes a displacement of the further displacement member relative to the further guide. The piston-cylinder unit favorably mechanically couples the further displacement member to the further guide. The piston could be mechanically connected, that is to say fixed, to the further guide, and the cylinder could be mechanically connected, that is to say fixed, to the further displacement member, or vice versa.

The flow valve could be capable of setting, that is to say the degree of throttling or restricting, respectively, of the volumetric flow in this instance could be set depending on the requirements. For example, the flow valve can be a throttle valve or an orifice valve. It could be provided that the flow valve is a controllable throttle valve, which is adjustable between an open state in which the maximum flow cross section (=free-running state of the restraining device) is set, and a state having a reduced flow cross section (=braking state of the restraining device).

In one preferred embodiment the restraining device has a switchable bypass, wherein the bypass fluidically connects the fluid receptacle spaces of the piston-cylinder unit in the free-running state. The bypass during fine-positioning is thus switched so as to be fluidically conducting and enables the substantially free movement of the piston of the piston-cylinder unit relative to the cylinder. The bypass in the braking state is blocked, wherein the fluid in this instance takes the route by way of the flow valve.

One preferred embodiment provides that the piston-cylinder unit has a piston having a double-sided piston rod. In the case of a piston having a double-sided piston rod, the annular face of the piston is favorably identical. On account thereof, an identical braking or damping effect, respectively, can be guaranteed in two opposite directions of movement of the piston. The fluid herein flows through the flow valve in two mutually opposite flow directions. It would also be possible for a piston having a one-sided piston rod to be used, wherein in this instance two dissimilarly set flow valves are favorably provided in order for an identical braking or damping effect, respectively, to be enabled in the two opposing displacement directions.

In one further potential embodiment the restraining device has a mechanical brake that is adjustable at least between an open position and a closed position. The mechanical brake of the restraining device in the closed position (=braking state of the restraining device) brakes a displacement of the further displacement member relative to the further guide more intensely than in the open position of the brake (=free-running state of the restraining device). The brake herein can be held in a non-displaceable manner on the further displacement member and be displaced relative to a slider piece that is connected in a non-displaceable manner to the further guide. On the other hand, the brake could also be connected in a non-displaceable manner to the further guide, and a slider piece that is connected to the further displacement member could be displaced relative to the brake.

Each displacement member, that is to say the displacement members of the actuation devices and the further displacement member of the at least one equalization device, favorably has at least one running roller that is supported on the guide or on the further guide. On account thereof, favorable friction conditions for the fine-positioning of the load-receiving device can be achieved. Alternatively, the guides in the sense of a roller guide can in each case have rollers on which the respective connecting member rolls. This in turn applies equally to the connecting member and the further connecting member.

In a method according to the invention for operating the transportation installation it is provided that at least one of the actuation drives, preferably all actuation drives, of the actuation devices in a fine-positioning state of the load-receiving device are actuated or capable of being actuated, respectively, for displacing the displacement member or the displacement members, and that the free-running state of the restraining device is set in the fine-positioning state. The actuation drives of the actuation devices are blocked and the braking state of the restraining device is set in a blocking state of the load-receiving device. The setting of the fine-positioning state or of the blocking state can be performed, for example, by a switch on the operating panel of the operator of the transportation installation. The fine-positioning state and the blocking state are favorably capable of being set in an alternating manner.

It could furthermore also be provided that the actuation drives of the actuation devices are blocked and the free-running state of the restraining device is set in an equalizing state of the load-receiving device. On account thereof, a rapid equalization of the cable forces can be forced by the operator. However, the optional equalizing state could also be provided automatically by the controller when overcoming a specific vertical lifting height of the load-receiving device, or by virtue of cable forces that are measured in the cables.

The invention furthermore provides a crane, preferably a gantry crane, having at least one transportation installation, wherein the crane trolley is mounted so as to be repositionable on a crane girder of the crane.

### BRIEF DESCRIPTION OF THE DRAWINGS

Further features and details of preferred design embodiments of the invention will be explained using exemplary embodiments of transportation installations according to the invention and of a crane according to the invention illustrated in the figures in which:

FIGS. 1 and 2 show schematic illustrations of a crane according to the invention in two operating positions;

FIG. 3 shows an isometric illustration of a first exemplary embodiment of a transportation installation of the crane according to FIG. 1;

FIG. 4 shows the detail A of FIG. 3, wherein an equalization device of the transportation installation is illustrated in a first terminal position;

FIG. 5 shows an illustration analogous to that of FIG. 4, having the equalization device in a second terminal position;

FIG. 6 shows a view in a direction that is parallel with a crane trolley rail, corresponding to FIG. 5;

FIG. 7 shows an illustration analogous to that of FIG. 6, wherein the equalization device is shown in the terminal position shown in FIG. 4;

FIG. 8 shows a lateral view of a piston-cylinder unit of the equalization device of the first exemplary embodiment of the transportation installation;

FIG. 9 shows a longitudinal section through the piston-cylinder unit shown in FIG. 8;

FIG. 10 shows a schematic of the hydraulics of the restraining device of the first exemplary embodiment of the transportation installation;

FIG. 11 shows a second exemplary embodiment of a transportation installation according to the invention;

FIG. 12 shows the detail B of FIG. 11;

FIGS. 13 and 14 show the equalization device of the second exemplary embodiment of the transportation installation in the braking state and in the free-running state;

FIG. 15 shows a third exemplary embodiment of a transportation installation according to the invention; and

FIG. 16 shows the detail C of FIG. 15.

### DETAILED DESCRIPTION

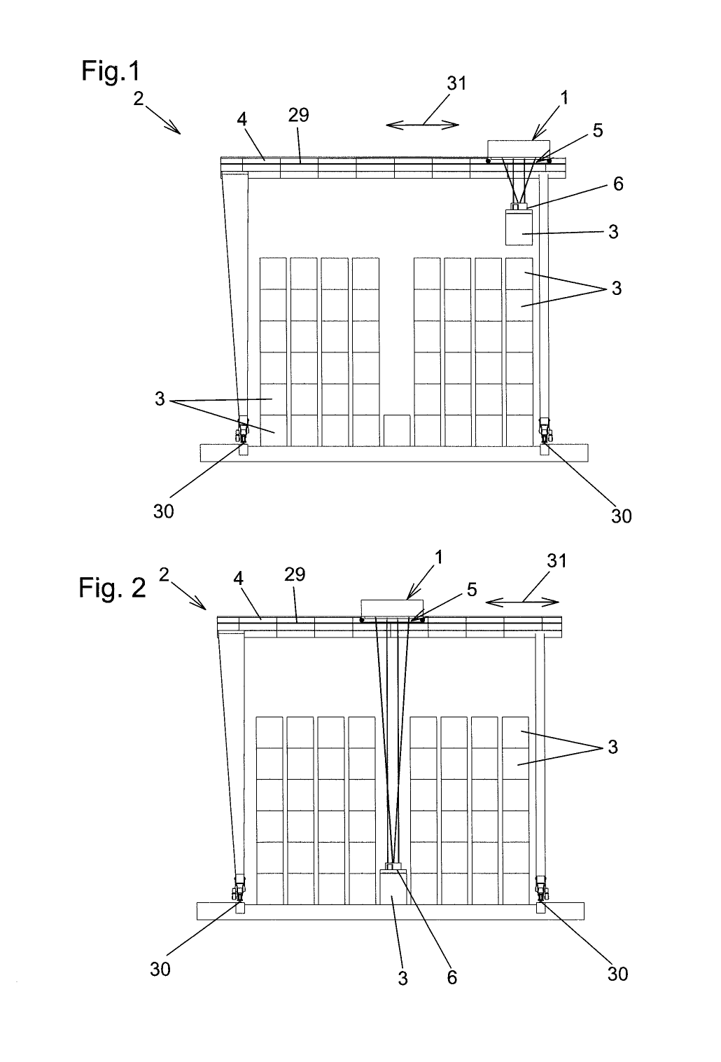

FIG. 1 shows a crane 2 which is configured as a gantry crane and which along crane rails 30 is displaceable in a direction that is orthogonal to the drawing plane, wherein the crane 2 by way of crane running gears (not referred to in more detail) is supported on the crane rails 30. The crane 2 has a crane girder 4 which is supported on vertical supports (not referred to in more detail) and on which a crane trolley 5 of a transportation installation 1 is mounted so as to be repositionable. The crane trolley 5 by crane trolley rollers (not referred to in more detail) is supported on crane trolley rails 29 which are installed along the crane girder 4. The transportation installation 1 furthermore has a load-receiving device 6 for receiving a container 3 or any other load which is suspended so as to be liftable and lowerable on the crane trolley 5 by cables 7 to 14 of the transportation installation 1. The double arrow 31 highlights the potential directions of movement of the transportation installation 1.

The crane girder 4 of the crane 2 bridges a storage area for containers 3 or other loads. A respective container 3 can be manipulated, that is to say moved from a container receiving space to a container parking space, by repositioning the crane 2 along the crane rails 30 and by repositioning the transportation installation 1 along the crane trolley rails 29, and by lifting and lowering the load-receiving device 6.

The cables 7 to 14 which are not specifically identified in FIGS. 1 and 2 define the so-called cable tower which extends from the crane trolley 5 to the load-receiving device 6. The geometry of the cable tower is variable and depends on the vertical spacing of the load-receiving device 6 from the crane trolley 5, as can clearly be derived from a comparison of FIGS. 1 and 2.

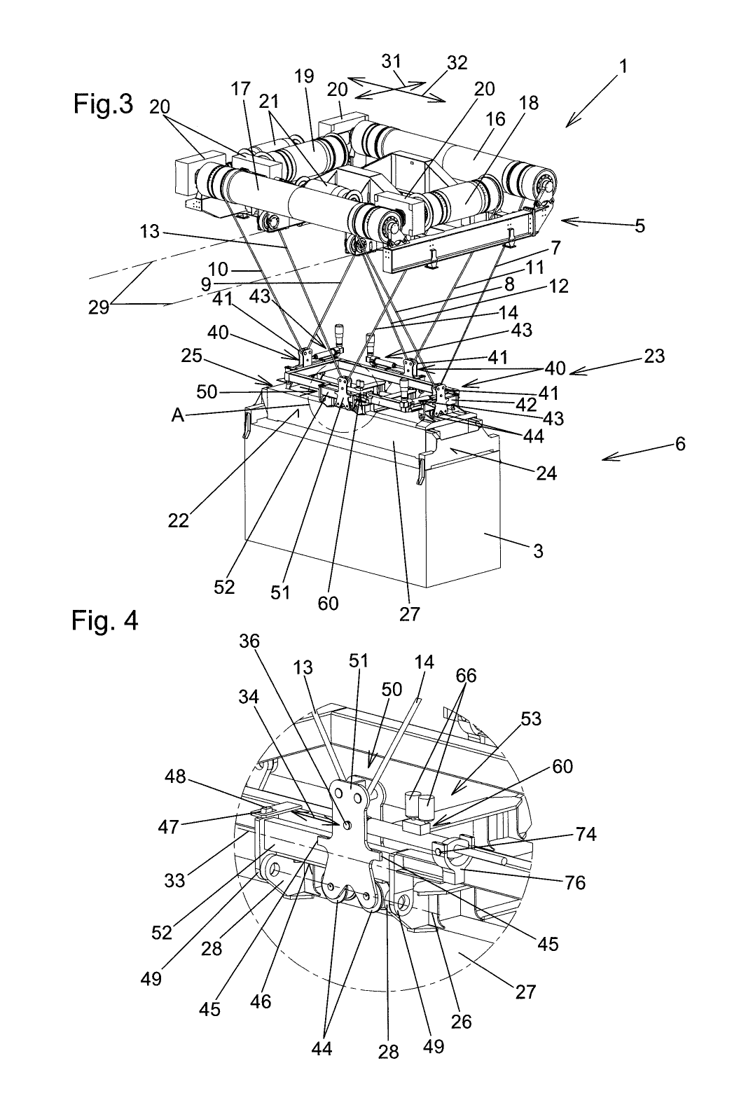

One end of a respective cable 7 to 14 is capable of being wound onto the cable drums 16 to 19. The transportation installation 1 in the first exemplary embodiment has four cable drums 16 to 19, wherein the cables 7 and 9 are capable of being wound onto the cable drum 16, the cables 8 and 10 are capable of being wound onto the cable drum 17, the cables 11 and 14 are capable of being wound onto the cable drum 18, and the cables 12 and 13 are capable of being wound onto the cable drum 19 (cf. FIG. 3). The transportation installation 1 for actuating the cable drums 16 to 19 has drive motors 21 and a gear set 20. The cable drums 16 and 17 in the exemplary embodiment are actuated in a synchronous manner and are driven by a common drive motor 21 and two gear sets 20 that are coupled to the drive motor 21. The cable drums 18 and 19 are also mechanically intercoupled and capable of being driven by a common drive motor 21 and two gear sets 20. The entirety of the cable drums 16 to 19, of the gear sets 20, and of the drive motors 21 could also be referred to as the lifting gear of the transportation installation 1. All the above is known per se and need not be explained in more detail. In another embodiment, all cables could be capable of being wound onto a single cable drum, or in each case four of the cables could be capable of being wound onto in each case one cable drum. Arrangements of this type are also known.

The crane girder for reasons of clarity is omitted in FIG. 3, and the crane trolley rails 29 are indicated in dashed lines. In a manner analogous to FIGS. 1 and 2, the double arrow 31 highlights the mutually opposite directions of movement of the crane trolley 5 relative to the crane girder 4, or the crane trolley rails 29, respectively. The double arrow 32 highlights the mutually opposite directions of movement of the crane 2 along the crane rails 30. Rough positioning of the load-receiving device 6 is performed by a movement of the crane 2 along the crane rails 30 and/or by a movement of the crane trolley 5 relative to the crane girder 4.

The transportation installation 1 has three actuation devices 40. Each actuation device 40 comprises a displacement member 41 which is mounted so as to be displaceable along a respective guide 42 of the load-receiving device 6. In each case two of the cables 7, 8; 9, 10; 11, 12 engage on the respective displacement member 41. It is provided in the exemplary embodiment that in each case one end of a respective cable 7 to 12 by a cable anchor (not referred to in more detail) is anchored to the respective displacement member 41. Cable anchors of this type, which are also referred to as end-of-cable connections are well known and need not be explained any further.

The transportation installation 1 furthermore has an equalization device 50. The equalization device 50 comprises a further displacement member 51 which per se is configured so as to be identical to the displacement members 41 of the actuation devices 40 already explained. The further displacement member 51 of the equalization device 50 is mounted so as to be displaceable on a further guide 52 of the load-receiving device 6. Two of the cables 13, 14 also engage on the further displacement member 51. One end of the respective cable 13, 14 is anchored to the further displacement member 52.

The equalization device 50 furthermore comprises a restraining device 53 that is capable of being set for selective restraint. The restraining device 53 is adjustable at least between a braking state and a free-running state. The restraining device 53 in the braking state brakes a displacement of the further displacement member 51 relative to the further guide 52 more intensely than in the free-running state.

A respective actuation device 40 furthermore has an actuation drive 43 for displacing the position of the displacement member 41 of the respective actuation device 40 relative to the respective guide 42. The actuation drives 43 furthermore also enable blocking or fixing of the position of the displacement member 41 relative to the respective guide 42. In the exemplary embodiment the actuation drive 43 of the respective actuation device 40 is embodied as an electric spindle drive. Other actuators, for example hydraulic piston-cylinder units, rack-and-pinion gear motors, linear motors, etc. could also be used instead of an electric spindle drive.

Due to a displacement of the displacement members 41 of the actuation devices 40 relative to the respective guide 42, a relative displacement of the corresponding engagement points of the cables 7 to 12 relative to the load-receiving device 6 is performed. Due to this, a precise positioning of the load-receiving device 6 for receiving or setting down the container 3 or the other load can be performed in a fine-positioning state. The free-running state of the restraining device 53 is favorably set during fine-positioning; that is to say that the further displacement member 51 is displaceable in a substantially free manner relative to the further guide 52. In the event of a displacement of the further displacement member 51 relative to the further guide 52 substantially only friction forces have to be overcome in the free-running state of the restraining device 53, that is to say that the restraining device 53 brakes a displacement of the further displacement member 51 relative to the further guide 52 only weakly as compared to the braking state. The movement of the further displacement member 51 of the equalization device 50 herein is performed in a self-acting manner by virtue of dissimilarly high cable forces of the cables 13, 14 that engage on the further displacement member 51, while overcoming the residual friction which in the free-running state has to be overcome in order for the further displacement member 52 to be displaced.

The actuation devices 40 in the fine-positioning state enable a movement of the load-receiving device 6, or of the container 3, respectively, in the directions that are identified by the double arrow 32 and the double arrow 31, that is to say in the plane that is defined by the double arrows 31, 32, and a rotation of the load-receiving device 6 relative to the crane trolley 5 about the vertical axis that is aligned so as to be orthogonal to the plane mentioned.

In a blocking state of the load-receiving device 6 the position of the displacement member 41 of the respective actuation device 40 relative to the respective guide 42 is fixed or blocked, respectively, by the respective actuation drive 43. The blocking state of the load-receiving device 6 is activated during the rough positioning. The braking state of the restraining device 53, which permits a displacement of the further displacement member 51 relative to the further guide 52, is set in the blocking state of the load-receiving device 6. The displacement of the further displacement member 51 relative to the further guide 52 is however braked more intensely than in the free-running state of the restraining device 53. Due to this, inequalities in the cable forces of the cables 7 to 14 can also be equalized in the blocking state of the load-receiving device 6 by way of a displacement of the further displacement member 51 relative to the further guide 52. This can be advantageous, for example, when overcoming a large vertical lift of the load-receiving device 6, since dissimilar cable forces can arise in the winding of the cables 7 to 14 when winding the cables 7 to 14, for example by virtue of dissimilar cable diameters or by virtue of dissimilar cable elongations of the cables 7 to 14. A certain equalization of the cable forces during the rough positioning can also be performed in the event of containers 3 that are loaded in a non-uniform manner. The restraining device 53 in the braking state of the restraining device 53 moreover causes high accelerations or force impulses, respectively, which could lead to reciprocating or rotating movements of the load-receiving device 6 about a vertical axis to be damped by virtue of the intense braking.

In summary, the equalization device 50 in the fine-positioning state and in the blocking state of the load-receiving device 6 enables a self-acting equalization or balancing, respectively, of the cable forces of the cables 7 to 14 of the transportation installation 1. Due to the equalization device according to the invention, any blocking of the further connecting member 51 which can lead to high cable forces is prevented in particular, since a relative displacement of the further displacement member 51 relative to the further guide 52 is also possible in the braking state. Overall, the service life of the cables 7 to 14 can thus be prolonged.

Prior to discussing the specific embodiment of the restraining device 53 of the first exemplary embodiment of the transportation installation 1, the structural properties of the load-receiving device 6, of the guides 41, 52, and of the connecting members 41, 51 of the transportation installation 1 are yet to be explained hereunder. When mention of the guides 42, 52 is made hereunder, the guides 42 on which the displacement members 41 of the actuation devices 40 are displaceably mounted and also the further guide 52 on which the further displacement member 51 of the equalization device 50 is displaceably mounted are referred to in equal measure. The same applies in an analogous manner to the explanations hereunder pertaining to the displacement members 41, 52, said explanations applying to the displacement members 41 of the actuation devices 40 and to the further displacement member 51 of the equalization device 50.

The load-receiving device 6 has two mutually opposite longitudinal sides 22, 23 and two mutually opposite end sides 24, 25 that are aligned so as to be orthogonal to the longitudinal sides 22, 23. The longitudinal sides 22, 23 in relation to the end sides 24, 25, when viewed orthogonally to the plane defined by the double arrows 31, 32, have a greater length. In each case one of the guides 42, 52 is disposed on each of the longitudinal sides 22, 23 and end sides 24, 25. A respective one of the guides 42, 52 in the exemplary embodiment is aligned so as to be parallel with the respective longitudinal side 22, 23 or end side 24, 25. A respective one of the guides 42, 52 is elongate along a longitudinal axis 33, wherein the longitudinal axes 33 of the guides 42, 52 are aligned so as to be parallel with the longitudinal sides 22, 23 or end sides 24, 25 on which the respective one of the guides 42, 52 is disposed. The equalization device 50 is disposed on the longitudinal side 22 of the load-receiving device 6, cf. FIG. 3.

A respective one of the guides 42, 52, that is to say a respective guide 42 that is assigned to the actuation devices 40 and the guide 52 that is assigned to the equalization device 50, in the exemplary embodiment in a manner relative to a support structure 27 of the load-receiving device 6 is pivotable about a pivot axis 26 that is aligned so as to be parallel with the longitudinal axis 33 of the guide 42, 52. The pivot axis 26 is plotted in FIGS. 4 to 7, for example. The pivoting of the guides 42, 52 enables a self-acting alignment of the respective connection member 41, 51 into a plane which is defined by the respective cables 7, 8; 9, 10; 11, 12; 13, 14 that engage on the respective connection member 41, 51. Deformations of the cable tower can be compensated for on account thereof. Each of the guides 42, 52 has lugs 49 having a passage opening for a bolt (not illustrated), cf. FIG. 4.

The lower part of the load-receiving device 6, which bears the weight of the container 3 or other load and directs it to the individual guides 42, 52 is referred to as the support structure 27. The support structure 27 likewise has lugs 28 with a passage opening, one of the lugs 28 being connected in an articulated manner, cf. FIG. 4, to one of the lugs 49 of the guide 42, 52 by means of said bolt (not illustrated). The longitudinal axis of the bolt runs along the pivot axis 26. Bolt-lug connections of this type are well-known.

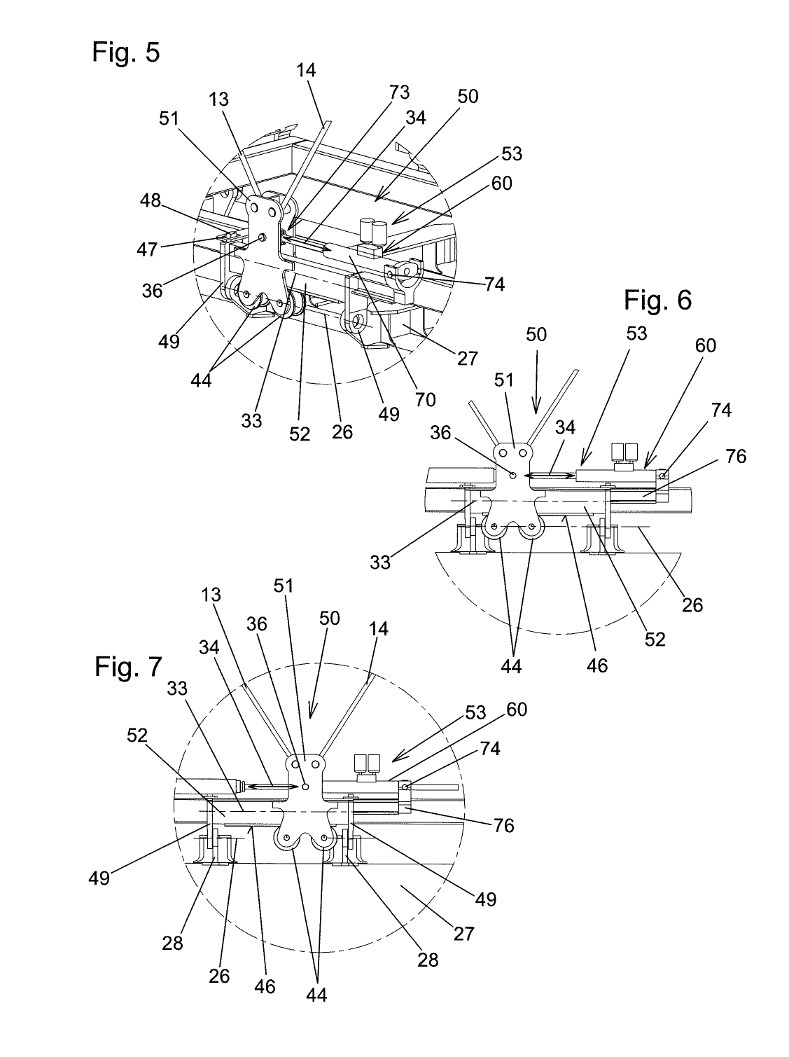

The pivot angle of the guide 42, 52 about the pivot axis 26 is limited in the exemplary embodiment. To this end, an appendage 48 that is configured on one of the lugs 49 engages in a clearance 47 of a further lug (not referred to in more detail) of the support structure 27, cf. FIGS. 4, 5. The pivot angle of the guide 42, 52 about the pivot axis 26, proceeding from a central position, is favorably in a range from +/−15°, for example +/−5°.

A respective one of the guides 42, 52 has a running face 46 on which running rollers 44 that are rotatably mounted on the respective displacement member 41, 52 roll, cf. FIG. 4.

The displacement path of the respective displacement member 41, or of the further displacement member 51, respectively, relative to the respective guide 42, or to the further guide 52, respectively, proceeding from a central position in the direction of the respective longitudinal axis 33 is favorably in a range from at least +/−100 mm. The displacement path proceeding from a central position in the exemplary embodiment is +/−200 mm. One of the terminal positions in which the further displacement member 51, proceeding from the central position, is displaced by 200 mm in a first displacement direction is illustrated in FIG. 4. FIG. 5 in turn shows the other one of the terminal positions in which the further displacement member 51, proceeding from the central position, is displaced by 200 mm in a second displacement direction that is opposed to the first displacement direction. All this relates to a displacement parallel with the longitudinal axis 33 of the guide 52, wherein the double arrow 34 highlights the first and the second displacement direction of the respective displacement member 51. The displacement members 41 of the actuation devices 40 are also capable of being repositioned in an analogous manner relative to the respective guide 42 to the extent of the displacement path mentioned. This has not been separately illustrated.

A respective connection member 41, 51 in the exemplary embodiment has detents 45 which by impacting one of the lugs 49 of the respective guide 42, 52 delimit the displacement path of the connection member 41, 51 in the displacement directions mentioned. The impact of the detents 45 on the lugs 49 is not separately illustrated.

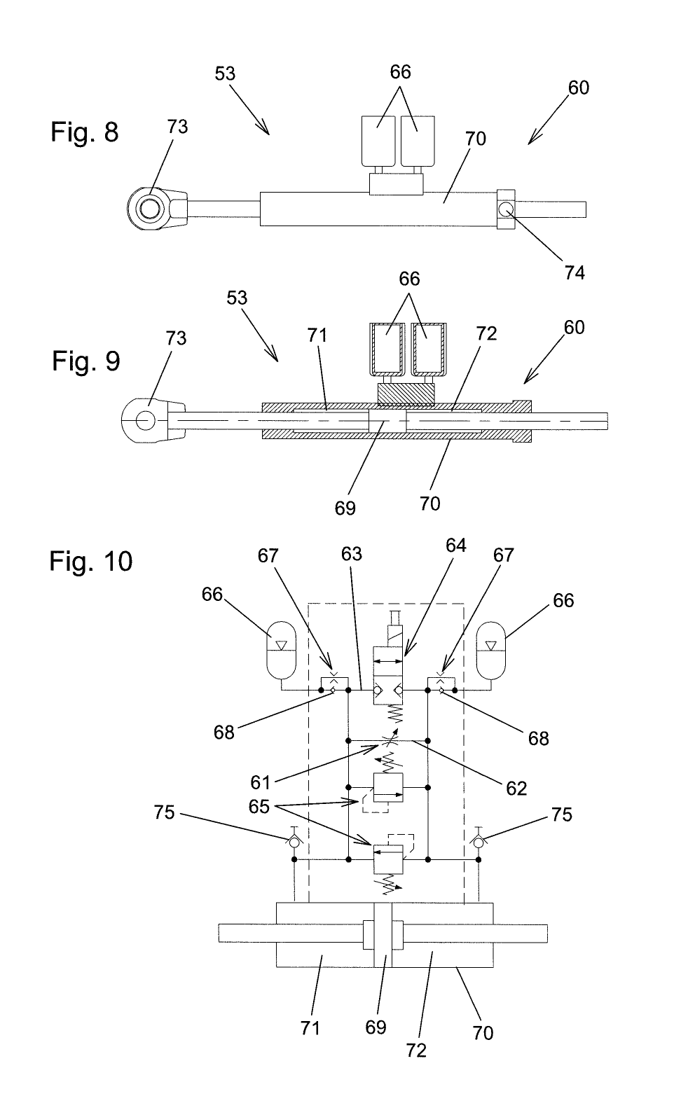

In the first exemplary embodiment of the transportation installation 1 the restraining device 53 of the equalization device 50 has a piston-cylinder unit 60 that is capable of being filled with a fluid, for example a hydraulic oil. The piston-cylinder unit 60 has a swivel head 73 which by a bolt 36 is connected in an articulated manner to the further connection member 51, cf. FIGS. 4, 8. The piston-cylinder unit 60 is connected to the guide 52 by way of pins 74 and an assembly console 76 that is fastened to one of the lugs 49 of the guide 42. The piston-cylinder unit 60 mechanically couples the further displacement member 51 to the further guide 52.

It is provided in the exemplary embodiment that the piston-cylinder unit 60 has a cylinder 70 and a piston 69 having a two-sided piston rod, that is to say that the two-sided piston rod penetrates the cylinder 70 on two opposite sides, cf. FIG. 9. The piston 69 mutually separates a first fluid receptacle space 71 and a second fluid receptacle space 72 of the piston-cylinder unit 60. The mutually opposite annular faces of the piston 69 have the same surface area. Due to this, identical repositioning speeds in the tensile and the compressive direction of the piston-cylinder unit 60 can be guaranteed at the same volumetric flow. The swivel head 73 mentioned is disposed on one end of the two-sided piston rod, cf. FIG. 9.

The restraining device 53 in the first exemplary embodiment furthermore has a flow valve 61 for restricting a volumetric flow of the fluid, cf. FIG. 10. The flow valve 61 is disposed in a fluid line 62 which connects the two fluid receptacle spaces 71, 72 of the cylinder 70 of the piston-cylinder unit 60. The flow valve 61 in the exemplary embodiment is configured as a throttle valve that is capable of being set in order for the braking effect in the braking state to be set so as to correspond to the requirements. This is performed, for example, in the initial commissioning of the crane 2. An orifice valve could also be used instead of a throttle valve.

The restraining device 53 in the exemplary embodiment has a switchable bypass 63 which in the free-running state fluidically interconnects the two fluid receptacle spaces 71, 72 of the cylinder 70. A switchover valve 64 which is switchable between a closed position and an open position is disposed in the bypass. The open position of the switchover valve 64 is set in the free-running state of the restraining device 53, that is to say that the piston 69 is displaceable relative to the cylinder 70 with a small effort in terms of force, wherein a fluid flow of the fluid between the fluid receptacle spaces 71, 72 takes place by way of the bypass 63.

FIG. 10 shows the braking state in which the closed position of the switchover valve 64 is set, and the bypass 63 is thus blocked. The fluid flow between the fluid receptacle spaces 71, 72 takes place by way of the flow valve 61, wherein the flow valve 61 restricts the volumetric flow of the fluid as compared to the free-running state. Due to this, the displacement of the piston 69 relative to the cylinder 70, and thus also of the further displacement member 51 relative to the further guide 52, is intensely braked.

The restraining device 53 in the first exemplary embodiment has optional pressure control valves 65 which when high fluid pressures arise which are beyond a set limit pressure of the pressure control valve 65 enable an overflow of fluid. Each of the pressure control valves 65 that is switched in parallel with the flow valve 61 enables the overflow in mutually opposing flow directions of the fluid, cf. the arrows which are plotted in the symbols of the pressure control valves 65. The restraining device 53 in the first exemplary embodiment furthermore has two fluid reservoirs 66 for receiving fluid. An orifice 67 and a stop valve 68 which are likewise optional are disposed in the supply line of a respective fluid reservoir 66. The piston-cylinder unit 60 is capable of being filled with fluid by way of connectors 75.

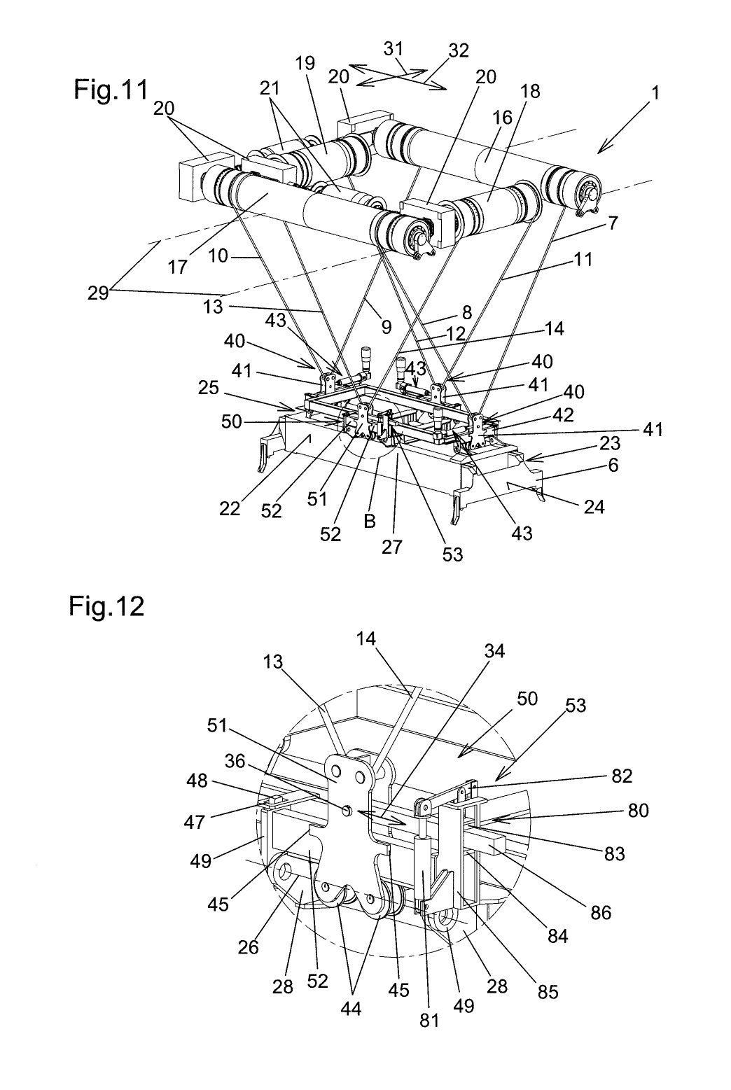

A second exemplary embodiment of a transportation installation 1 according to the invention is illustrated in FIGS. 11 to 14. This second exemplary embodiment of a transportation 1 could be used in the crane 2 according to FIGS. 1 and 2 instead of the transportation installation 1 of the first exemplary embodiment illustrated in FIGS. 3 to 10. The structural design of the transportation installation 1, with the exception of the equalization device 50, corresponds largely to that of the first exemplary embodiment such that reference is made mainly to the points of differentiation in relation to the first exemplary embodiment of the transportation installation 1 in the explanations pertaining to the second exemplary embodiment. With the exception of the points of differentiation set forth hereunder, the explanations pertaining to the first exemplary embodiment of the transportation installation 1 thus also apply to the second exemplary embodiment.

The second exemplary embodiment of a transportation installation 1 is shown in an isometric illustration in FIG. 11, wherein only the lifting gear of the crane trolley 5 is illustrated. The crane trolley 5 otherwise is embodied so as to be identical to the first exemplary embodiment. Furthermore, the arrangements of the cables 7 to 14 and of the actuation devices 40 are embodied so as to be identical to the first exemplary embodiment, such that reference is yet again made at this point to the corresponding explanations pertaining to the first exemplary embodiment.

One difference of the second exemplary embodiment of the transportation installation 1 lies in that the equalization device 50 comprises the restraining device 53 which has a mechanical brake 80 that is adjustable at least between an open and a closed state, cf. FIG. 12. In other words, a piston-cylinder unit of the equalization device is dispensed with in the case of the second exemplary embodiment.

The equalization device 50 of the second exemplary embodiment comprises a slider piece 86 which by way of the bolt 36 is connected to the further connection member 51, said slider piece 86 being configured as a bar having a rectangular cross section. The slider piece 86 conjointly with the further connection member 51 is displaceable in the mutually opposing displacement directions parallel with the pivot axis 26 and the longitudinal axis 33, highlighted by the double arrow 34. The slider piece 86 in another variant of embodiment could also have another cross section, for example a circular cross section.

The brake 80 has a brake console 85 that is fixedly connected to the guide 52, and a stationary brake block 84 which is fastened to the brake console 85. The brake 80 furthermore comprises a movable brake block 83 which, by way of a pivotable lever 82 which is connected in an articulated manner to the movable brake block 83, is displaceable relative to the brake console 85 and to the stationary brake block 84. The lever 82 is pivotable by an actuator 81 which is supported on the brake console 85, thus enabling an adjustment of the movable brake block 83 relative to the stationary brake block 84. The slider piece 86 is disposed between the stationary brake block 84 and the movable brake block 83 and is displaceable relative to the brake blocks 83, 84.

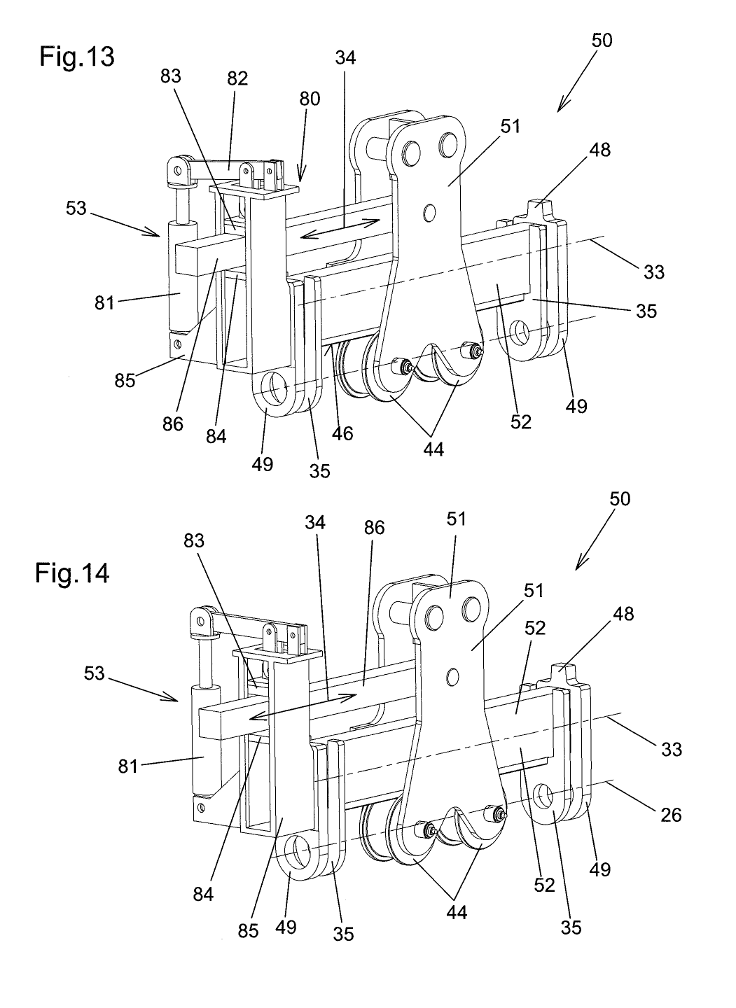

The brake 80 by way of a corresponding actuation of the actuator 81 is adjustable between an open position and a closed position. The closed position of the brake 80 is set in the braking state of the restraining device 53, wherein the movable brake block 83 and the stationary brake block 84 bear on the slider piece 86 by way of a predeterminable braking force, cf. FIG. 13. The open position of the brake 80 is set in the free-running state, wherein the movable brake block 83 is raised from the slider piece 86, a substantially free displacement capability of the slider piece 86 relative to the brake 80 thus being enabled. With the exception of a dynamic friction between the slider piece 86 and the stationary brake block 84, only a weak braking action of the displacement of the slider piece 86 relative to the brake 80 is thus effective in the free-running state, cf. FIG. 14.

The restraining device 53 in the braking state brakes a displacement of the slider piece 86 relative to the brake 80 more intensely than in the free-running state. It is thus provided also in the case of the second exemplary embodiment of the transportation installation 1 that a displacement of the further displacement member 51 relative to the further guide 52 is at all times also possible in the braking state of the restraining device 53. A limit force can be preselected by setting a predetermined braking force in the braking state. A self-acting displacement of the further displacement member 51 relative to the further guide 52 takes place when they limit force is exceeded, for example as a result of a correspondingly high difference between the cable forces of the cables 13, 14 that engage on the further displacement member 51. The displacement of the further displacement member 51 relative to the further guide 52 in the braking state is thus also braked more intensely than in the free-running state in the case of the second exemplary embodiment.

The restraining device 53 according to the second exemplary embodiment of the transportation installation 1 is illustrated from another perspective in FIGS. 13 and 14. In an exemplary manner, additional lugs 35 which delimit the displacement path of the further displacement member 51 in the mutually opposing displacement directions (indicated by the double arrow 34) are illustrated by contrast to the further guide 52 illustrated in FIG. 12. The respective lug 28 of the support structure 27 is disposed between the lug 49 of the guide 52 and the additional lugs 35. This is not separately illustrated.

The actuator 81 of the brake 80 can have a rack and a drivable gear wheel which meshes with the rack. The actuator 81 in the exemplary embodiment is a spindle drive. The actuator 81 could alternatively also be a piston-cylinder unit.

In one other design embodiment it is conceivable and possible for the brake 80 to be fixedly connected to the connection member 51, and for the slider piece 86 to be fixedly held so as to be non-displaceable on the further guide 52.

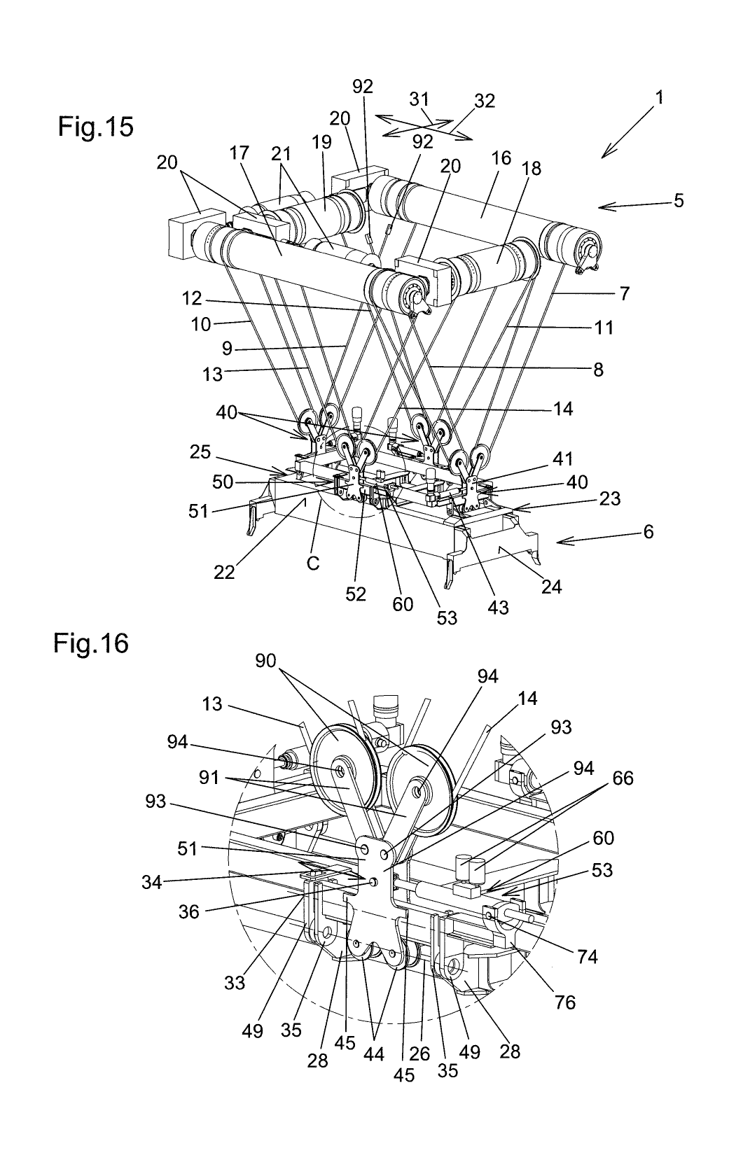

A third exemplary embodiment of a transportation installation 1 according to the invention is illustrated in FIGS. 15 and 16. Said third exemplary embodiment of a transportation installation 1 could be used in the crane 2 according to FIGS. 1 and 2 instead of the transportation installation 1 of the first exemplary embodiment illustrated in FIGS. 3 to 10. The structural design of the load-receiving device 6 and in particular of the restraining device 53 are embodied so as to be identical to the first exemplary embodiment such that reference is made mainly to the points of differentiation in relation to the first exemplary embodiment of the transportation installation 1 in the explanations pertaining to the third exemplary embodiment. With the exception of the points of differentiation set forth hereunder, the explanations pertaining to the first exemplary embodiment of the transportation installation 1 thus also apply to the third exemplary embodiment.

The third exemplary embodiment of a transportation installation 1 is shown in an isometric illustration in FIG. 15, wherein only the lifting gear of the crane trolley 5 is illustrated.

The third exemplary embodiment of the transportation installation 1 differs from the first exemplary embodiment in that a respective displacement member 41 has two deflection rollers 90. The further displacement member 51 also has two deflection rollers 90. A respective cable 7 to 14 in the third exemplary embodiment is deflected on the deflection roller 90, wherein that end of the cable 7 to 14 that faces away from the respective cable drum 16 to 19 is anchored to the crane trolley 5 by an end-of-cable connection 92. In each case two of the cables 7 to 14 thus engage on the respective displacement member 41 or on the further displacement member 51 also in the case of the third exemplary embodiment, wherein a respective cable 7 to 14 is deflected on the deflection roller 90, and in each case two cable strands of the cables 7 to 14, proceeding from the deflection roller 90, are guided in the direction toward the crane trolley 5. The effective cable forces in the respective cable 7 to 14 are reduced on account of the deflection of the cables 7 to 14, since the total tensile force is split among the two cable strands that run in a substantially mutually parallel manner.

Only two of the end-of-cable connections 92 are visible in FIG. 15. The further end-of-cable connections are obscured by the components of the lifting gear. The fastening of the end-of-cable connections 92 to the crane trolley 5 is not illustrated in detail in order for the end-of-cable connections 92 to be shown. End-of-cable connections 92 that are fastened to the crane trolley 5 are known per se in the prior art.

The respective deflection roller 90 is rotatably mounted on a connection element 91 of the displacement member 41, 51. Each connection element 91 in the exemplary embodiment is held in unarticulated manner on a main body 94 of the displacement member 41, or of the further displacement member 51, respectively, by a bolt 93, cf. FIG. 16. The articulated mounting of the connection element 91 enables a self-acting alignment of the connection element 91 in a direction which corresponds to the resulting direction of the cable forces that act in the cable strands of a respective cable 7 to 14.

In terms of the functioning mode of the equalization device 50 and of the actuation devices 40 reference is otherwise made to the explanations pertaining to the first exemplary embodiment.

It is additionally pointed out that the restraining device 53 in a modification according to the invention of the third exemplary embodiment could have a mechanical brake 80 in a manner analogous to that of the second exemplary embodiment instead of the piston-cylinder unit 60 shown.

A method according to the invention for operating the transportation installation 1 according to the first or to the second exemplary embodiment of the transportation installation 1 provides that at least one of the actuation drives 43, preferably all actuation drives 43, of the actuation devices 40 in the fine-positioning state of the load-receiving device 6 are actuated, or are capable of being actuated, respectively, for displacing the displacement member 41, or the displacement members 41. Furthermore, the free-running state of the restraining device 53 is set in the fine-positioning state such that a self-acting equalization of the cable forces of the cables 7 to 14 takes place. By virtue of the minor friction, the movement of the further displacement member 51 takes place so as to be substantially simultaneous with the displacement of the displacement members 41 of the actuation devices 40.

The actuation drives 43 of the actuation devices 40 are blocked and the braking state of the restraining device 53 is set in the blocking state of the load-receiving device 6. Due to this, a gradual equalization of cable force peaks takes place by way of a displacement of the further displacement member 51 relative to the further guide 52. Rapid movements or force impulses have an only comparatively minor influence on the movement of the further displacement member 52, on account of which instabilities on account of any rocking of the load-receiving device 6 can be avoided.

It is advantageous for an additional equalizing state to be provided, in particular when a mechanical brake 80 in which a limit force is set in the braking state is used. All actuation drives 43 of the actuation devices 40 are blocked, and the free-running state of the restraining device 53 is set to a limited period, for example to less than five seconds, in the equalizing state. This is advantageous in particular in the case of large lifting heights of the load-receiving device 6 in order for a short-term equalization of the cable forces to be enforced by the operator of the crane 2.

The restraining device 53 in the exemplary embodiments is adjustable between the braking state and the free-running state. It could be provided that one or a plurality of additional intermediate states are capable of being set between the braking state and the free-running state. On account thereof, a situation-dependent damping behavior or braking behavior, respectively, could be implemented. In the case of the first or the third exemplary embodiment of the transportation installation 1 this can be implemented by providing a plurality of switchable throttles or by providing a throttle control valve, for example. In the case of the second exemplary embodiment of the transportation installation 1, dissimilarly high braking forces could be set by the actuator 81.

In the exemplary embodiments of transportation installations 1 according to the invention explained, said exemplary embodiments comprise in each case eight cables 7 to 14, wherein two of the cables 7 to 12 engage on each displacement member 41, and the remaining two cables 13, 14 engage on the further displacement member 51. In other embodiments it would be conceivable and possible for the transportation installation to comprise more than eight cables, for example ten cables. In the case of ten cables it is then favorably provided that the transportation installation comprises three actuation devices and two equalization devices, wherein again two of the cables engage on each displacement member of the actuation devices, and two of the cables engage in each case on each further displacement member of the equalization devices. In a further exemplary embodiment it would also be conceivable for the transportation installation to comprise twelve cables, wherein in this instance three actuation devices and three equalization devices are favorably provided, wherein two of the cables engage in each case on each of the displacement members or the further displacement members, respectively.

### LIST OF REFERENCE SIGNS

1 Transportation installation
2 Crane
3 Container
4 Crane girder
5 Crane trolley
6 Load-receiving device
7 Cable
8 Cable
9 Cable
10 Cable
11 Cable
12 Cable
13 Cable
14 Cable
16 Cable drum
17 Cable drum
18 Cable drum
19 Cable drum
20 Gear set
21 Drive motor
22 Longitudinal side
23 Longitudinal side
24 End side
25 End side
26 Pivot axis
27 Support structure
28 Lug
29 Crane trolley rail
30 Crane rail
31 Double arrow
32 Double arrow
33 Longitudinal axis
34 Double arrow
35 Additional lug
36 Bolt
40 Actuation device
41 Displacement member
42 Guide
43 Actuation drive
44 Running roller
45 Detent
46 Running face
47 Clearance
48 Appendage
49 Lug
50 Equalization device
51 Displacement member
52 Guide
53 Restraining device
60 Piston-cylinder unit
61 Flow valve
62 Fluid line
63 Bypass
64 Switchover valve
65 Pressure control valve
66 Fluid reservoir
67 Orifice
68 Stop valve
69 Piston
70 Cylinder
71 First fluid receptacle space
72 Second fluid receptacle space
73 Swivel head
74 Pin
75 Connector
76 Assembly console
80 Brake
81 Actuator
82 Lever
83 Movable brake block
84 Stationary brake block
85 Brake console
86 Slider piece
90 Deflection roller
91 Connection element
92 End-of-cable connection
93 Bolt
94 Main body

1. A transportation installation for a crane for transporting at least one container or any other load, the transportation installation comprising:
a crane girder;
at least one crane trolley that is adapted to be repositionably mounted on a crane girder of the crane;
at least eight cables;
a load-receiving device suspended from the crane trolley by the at least eight cables such that the at least one load receiving device is liftable and lowerable, the load receiving device including guides;
at least three actuation devices, each of said actuation devices including:
a displacement member displaceably mounted on a respective one of the guides of the load-receiving device, and
an actuation drive that is adapted to displace a position of the displacement member relative to the respective guide;
two of the cables engage in each case on respective ones of the displacement members;
at least one equalization device having a further displacement member that is displaceably mounted on a further guide of the load-receiving device and on which two of the at least eight cables engage; and
a restraining device that is settable for selective restraint, the restraining device being adjustable at least between a braking state and a free-running state, and the restraining device in the braking state brakes a displacement of the further displacement member relative to the further guide more intensely than in a free-running state.

2. The transportation installation according to claim 1, wherein the load-receiving device includes two mutually opposite longitudinal sides and two mutually opposite end sides that are aligned orthogonal to the longitudinal sides, and one of the guides is aligned parallel with and disposed on each of the respective longitudinal sides and end sides.

3. The transportation installation according to claim 2, wherein the equalization device is disposed on one of the longitudinal sides of the load-receiving device.

4. The transportation installation according to claim 1, wherein a respective one of the guides is pivotable relative to a support structure of the load-receiving device about a pivot axis that is aligned parallel with a longitudinal axis of the guide.

5. The transportation installation according to claim 1, wherein the restraining device includes a piston-cylinder unit that is adapted to be filled with a fluid, and a flow valve that is adapted to restrict a volumetric flow of the fluid.

6. The transportation installation according to claim 5, wherein the piston-cylinder unit includes a piston having a double-sided piston rod.

7. The transportation installation according to claim 1, wherein the restraining device includes a mechanical brake that is adjustable at least between an open position and a closed position.

8. The transportation installation (1) according to claim 1, wherein at least one of the respective displacement members or the further displacement member includes at least one running roller that is supported on the respective guide or on the further guide, respectively.

9. A method for operating the transportation installation (1) according to claim 1, comprising:
actuating at least one of the actuation drives of the actuation devices in a fine-positioning state of the load-receiving device and displacing at least one of the displacement members;
setting the free-running state of the restraining device in the fine-positioning state; and
blocking the actuation drives of the actuation devices and setting the braking state of the restraining device in a blocking state of the load-receiving device.

10. A crane comprising at least one transportation installation according to claim 1, and the at least one crane trolley is repositionably mounted on a crane girder (4) of the crane (2).
